(19) United States
(12) Patent Application Publication
(10) Pub. No.: US 2017/0064612 A1
(43) Pub. Date: Mar. 2, 2017

(54) METHOD FOR DISCOVERING SERVICES

(71) Applicant: MediaTek Singapore Pte. Ltd., Singapore (SG)

(72) Inventors: Gabor Bajko, Santa Clara, CA (US); Chao-Chun Wang, Taipei City (TW)

(21) Appl. No.: 15/308,099

(22) PCT Filed: May 6, 2015
(86) PCT No.: PCT/SG2015/050098

§ 371 Date: Nov. 1, 2016

Related U.S. Application Data
(60) Provisional application No. 61/989,060, filed on May 6, 2014.

(51) Int. Cl. H04W 48/12; H04W 72/04

(52) U.S. Cl. CPC H04W 48/12; H04W 72/0433; H04W 84/12

(57) ABSTRACT

A method for a wireless device to provide/discover a service is provided. The method comprises operating the wireless device as a hotspot in an operating channel, and advertising service information by the wireless device through an awareness channel to another wireless device.

### CROSS REFERENCE TO RELATED APPLICATIONS

This application claims priority under 35 U.S.C. §119 from U.S. Provisional Application No. 61/989,060, entitled “Discovering services hosted by HS2.0 Rel-2 networks,” filed on May 6, 2014, the subject matter of which is incorporated herein by reference.

### TECHNICAL FIELD

The disclosed embodiments relate generally to wireless network communications method, and, more particularly, to a method to discover services in a wireless network communications system.

### BACKGROUND

Hot Spot 2.0 (HS 2.0), also called “Wi-Fi Certified Passpoint”, is a standard for public-access Wi-Fi that enables seamless roaming among Wi-Fi networks and between Wi-Fi and cellular networks. HS 2.0 was developed by the Wi-Fi Alliance and the Wireless Broadband Association to enable seamless hand-off of traffic without requiring additional user sign-on and authentication.

A hotspot can be differentiated from a wireless access point, which is the hardware device used to provide the wireless network service. A hot spot (or hotspot) is a wireless local area network (WLAN) node that provides Internet connection from a given location for users of devices with wireless connectivity and might include the function of an access point. Hotspots are common in hotels, airports, libraries, and coffee shops. Normally, a user must connect manually to a hotspot by checking the wireless connection options, selecting one, and entering authentication information, usually a simple password.

The HS 2.0 specification is based on a set of protocols called IEEE 802.11u, which facilitates cellular-like roaming, increased bandwidth, and service on demand for wireless-equipped devices in general. When a subscriber's 802.11u-capable device is in range of at least one Wi-Fi network, the device can automatically select a network and connects to it. Network discovery, registration, provisioning, and access processes can be automated, so that the user does not have to go through them manually in order to connect and stay connected.

If services are available at a HS2.0 capable Hotspot, the Hotspot AP sets a capability bit indicating the presence of such services in beacon and probe responses. The services can be hosted locally, such as “location-based” services, or the Hotspot can offer access to a walled garden where the service is available.

### SUMMARY

It is therefore an object of the present invention to provide a method for a wireless device to provide a service. The method comprises operating the wireless device as a hotspot in an operating channel, and advertising service information by the wireless device through an awareness channel to another wireless device.

According to an embodiment of the present invention, the awareness channel is a neighbor awareness network (NAN) channel.

It is therefore another object of the present invention to provide a method for a wireless device to discover a service. The method comprises operating the wireless device as a hotspot enabled station in an operating channel and s a neighbor awareness network role in an awareness channel. The wireless device then receives information of the service through the awareness channel.

It is therefore a further object of the present invention to provide a method for discovering a service. The method comprises operating a first wireless device as an access point according to neighbor awareness network service discovery protocol (SDP). A second wireless device then queries to the access point in an operating channel about the service with a SDP action frame. The first wireless device then responds information of the service with a SDP action frame to the second wireless device.

### BRIEF DESCRIPTION OF THE DRAWINGS

FIG. 1 illustrates a wireless network communications system according to an embodiment of the present invention.

### DETAILED DESCRIPTION

The awareness technology, such as Neighbor awareness networking (NAN) or Wi-Fi Aware, is a capability of Wi-Fi which enables power-efficient discovery of nearby information and services before making a connection. The awareness technology makes it easy to find services available in the area that match preferences set by the user—and is optimized to work well even in crowded environments. The awareness technology can be a key enabler of a personalized social, local, and mobile experience, enabling users to find video gaming opponents, share media content, and access localized information all before establishing a connection. For example, since service definitions, publication of the availability of a service or query for the availability of a service are specified in the NAN program, it can be leveraged in a Hotspot.

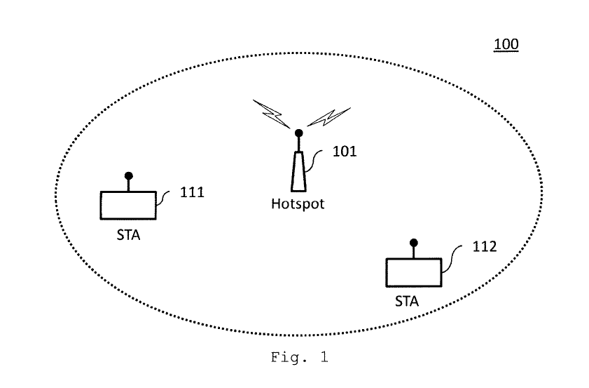

Please refer to FIG. 1, which illustrates a wireless network communications system 100 according to an example of the present invention. A plurality of stations, for example STA 111 and STA 112, are associated with an access point (AP) 101.

According to an embodiment of the present invention, AP 101 can be a wireless device with an AP role, such as a HS 2.0 release 2 capable Hotspot. AP 101 can also have a NAN role. Or, according to an embodiment of the present invention, AP 101 can have both roles at the same time.

When AP 101 plans to advertise services available through its Hotspot service, AP 101 can use awareness technology, such as using NAN channels, to publish service information. The service information can include, but not limited to, the name of the service, characteristics of the service or connection parameters needed to connect to the service. The connection parameters can be carried in a “service_specific_info” field according to the NAN publish and subscribe methods. However, the present invention can use any method to carry the connection parameters and is not limited herein.

According to an embodiment of the present invention, when AP 101 uses NAN channels to publish service information, AP 101 can use dual/multi radios. For example, AP 101 can operate as a Hotspot in operating channel(s), and operate NAN functionality in other channels, such as channels 6 or 149.

According to another embodiment of the present invention, when AP 101 uses NAN channels to publish service information, AP 101 can use concurrent dual band. For example, AP 101 performs Hotspot operation in one 5 GHz channel, and performs NAN operation in another channel, such as channel 6.

According to yet another embodiment of the present invention, when AP 101 uses NAN channels to publish service information, AP 101 can be a single band access point which switches between an operating channel and a NAN channel with the single band.

According to an embodiment, AP 101 may publish its service in the discovery window (DW) of the NAN channel. And the service information that may be carried by service_specific_info field of the Publish method may include, but not limited to, Service Set Identifier (SSID) of the Hotspot where the concierge service is available, Basic Service Set Identifier (BSSID) of the Hotspot AP where the concierge service is available, Channel of operation of the HS2.0 capable AP where the concierge service is available, Credentials usable to access the HS2.0 network (or at least access the walled garden with the concierge service), or Uniform Resource Identifier (URI) of the service.

At the station, such as the station STA 111 in FIG. 1, it can be implemented with two roles, one is a HS 2.0 Release 2 capable station, and the other one is a NAN role.

STA 111 can subscribe to concierge service as described in NAN when it finds the service it is looking for. STA 111 can switch to the channel indicated in the service information, such as the information carried in the aforementioned service_specific_info field. STA 111 can then use Access Network Query Protocol (ANQP) or guest access credentials to find the credentials it can use with the indicated BSSID. After that, STA 111 authenticates and associates with the AP 101. Then STA 111 is able to launch the browser or connect to the URI indicated in the service information.

According to an embodiment of the present invention, the URI may be the service itself (e.g. concierge, museum guide, etc), or it may contain a java script which can be downloaded to the device, or may contain additional information displayed by the browser to the user at STA 111 with instructions on what to do next to get access to the service. However, any information can be provided by the URI and is not limited to the examples given herein.

In this example, STA 111, as NAN role, learns not only about the service, but also skip the scanning steps that scanning for available services and channels, because STA 111 has all the information it needs with respect to which channel, which SSID or with what credentials STA 111 can get access to the service.

During the operation between AP 101 and STA 111, according to an embodiment of the present invention, only one channel can be exclusively used for publishing services. Or, in another embodiment, AP 101 and STA 111 can switch between Hotspot and NAN roles in one of the operating channels.

Therefore, the aforementioned embodiment provides a method to combine two features, HS 2.0 release 2 and NAN, and therefore reduces the effort to create a new specification.

According to another embodiment of the present invention, two wireless devices, such as AP 101 and STA 112, both implement the NAN Service Discovery Protocol (SDP). The NAN service discovery protocol is a public action frame defined in the NAN specification. Therefore, NAN synchronization or discovery beacon is not required

In this embodiment, AP 101 operates in its operating channel, and operates as an access point. Therefore, AP 101 supports the additional service discovery protocol (SDP) public action frame as specified in NAN. According to an embodiment of the present invention, STA 112 may query AP 101, which acts as the Hotspot, before or after association, in the operating channel, about the availability of services. So STA 112 needs to implement the SDP public action frame as specified in NAN. STA 112 then uses SDP action frame to query for services at AP 101, the Hotspot, using the NAN attributes applicable to SDP.

In response, AP 101 uses SDP action frame to respond to STA 121 about availability of services. The SDP action frame may comprise a service_specific_info field that contains the parameters needed to connect to the service (eg URI).

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a wireless device to provide a service, comprising:
operating the wireless device as a hotspot in an operating channel; and
advertising service information by the wireless device through an awareness channel.

2. The method of claim 1, wherein the awareness channel is a neighbor awareness network (NAN) channel.

3. The method of claim 2, wherein the advertising step is performed in a discover window of the NAN channel.

4. The method of claim 1, wherein the wireless device comprises at least 2 radios, and the wireless device operates as the hotspot in one radio and operates through the awareness channel in another radio.

5. The method of claim 1, wherein the wireless device comprises concurrent dual bands, and the wireless device operates as the hotspot in one of the concurrent dual bands, and operates through the awareness channel in another one of the concurrent dual bands.

6. The method of claim 1, wherein the wireless device comprises a single band, and the wireless device switches between the operating channel and the NAN channel with the single band.

7. The method of claim 1, wherein the service information comprises at least one of Service Set Identifier (SSID) of the Hotspot where the concierge service is available, Basic Service Set Identifier (BSSID) of the Hotspot AP where the concierge service is available, Channel of operation of the HS2.0 capable AP where the concierge service is available, Credentials usable to access the HS2.0 network (or at least access the walled garden with the concierge service), and Uniform Resource Identifier (URI) of the service.

8. A method for a wireless device to discover a service, comprising:
operating the wireless device as a hotspot enabled station in an operating channel;
operating the wireless device as a neighbor awareness network role in an awareness channel; and
receiving information of the service through the awareness channel.

9. The method of claim 8, further comprising,
switching to a channel indicated in the information of the service.

10. The method of claim 9, further comprising,
using Access Network Query Protocol (ANQP) or guest access credentials to find a credential used for a basic service identifier (BSSID) indicated in the service information.

11. The method of claim 8, wherein the receiving step is performed without scanning.

12. A method for discovering a service, comprising,
operating a first wireless device as an access point according to neighbor awareness network service discovery protocol (SDP);
querying by a second wireless device to the access point in an operating channel about the service with a SDP action frame; and
sending information of the service by the first wireless device with a SDP action frame to the second wireless device.

13. The method of claim 12, wherein the querying step is performed before or after an association between the first wireless device and the second wireless device.
